(19) United States
(12) Patent Application Publication
(10) Pub. No.: US 2016/0090029 A1
(43) Pub. Date: Mar. 31, 2016

(54) SAFETY BANNER

(71) Applicant: Andrei LEVYTSKY, East Rutherford, NJ (US)

(72) Inventor: Andrei LEVYTSKY, East Rutherford, NJ (US)

(21) Appl. No.: 14/861,306

(22) Filed: Sep. 22, 2015

Related U.S. Application Data
(60) Provisional application No. 62/055,645, filed on Sep. 25, 2014.
(60) Provisional application No. 62/121,585, filed on Feb. 27, 2015.

(51) Int. Cl. B60Q 1/52; B60J 11/04; B60Q 7/00

(52) U.S. Cl. CPC B60Q 1/52; B60Q 7/00; B60J 11/04

(57) ABSTRACT

The present disclosure provides for a safety device that draws attention to a designated area. This safety device is suitable for use in, for example, a vehicle that has just been in an accident, someone who has been marooned on an island, or a hiker who has gotten trapped on a mountain. The safety device is lightweight, portable, and easy to store.

### CLAIM OF PRIORITY

This application claims the priority of U.S. Ser. No. 62/055,645 filed on Sep. 25, 2014 and U.S. Ser. No. 62/121,585 filed on Feb. 27, 2015, the contents of which are hereby fully incorporated by reference.

### FIELD OF THE EMBODIMENTS

The invention and its embodiments relate to safety devices, namely a safety cover. In particular, the present invention and its embodiments relate to a reflective safety cover, optionally equipped with custom text, for use in drawing attention to objects for the purposes of safety.

### BACKGROUND OF THE EMBODIMENTS

Almost everyone who has been in a vehicle has been involved in some sort of accident. While unintended, accidents are a part of everyone's life. Many accidents occur in locations with an ample populous, and many other accidents occur in remote locations. In the latter, if the survivor becomes stranded, it can be a considerable amount of time before the survivor of this accident is located. Further, many victims of accidents are left in an incapacitated state, further decreasing their chances of survival when in a remote location.

Regardless of the location of the accident, it is paramount to inform others of the existence and location of said accident. In today's world there is no shortage of ways to inform people; cell phones, flare guns, smoke signals, and many other systems exist, but all of them have certain drawbacks. For example, cell phones require being connected to a cellular network, and must carry an electrical charge to operate. Flare guns do not have either of these limitations, however flares are transient, requiring a rescuer to have a line-of-sight with the flare at the time the gun was fired. Smoke signals do not have any of the drawbacks of the previously mentioned systems, however they can be quite onerous to maintain, something that an accident survivor is frequently unable to do.

Thus, there is a need for a safety device that may be used for long periods of time yet may also be highly portable and easy to carry. The present invention and its embodiments meet and exceed these objectives.

### REVIEW OF RELATED TECHNOLOGY

U.S. Pat. No. 5,456,515 pertains to a shade cover assembly designed to cover the windows of a vehicle. This cover assembly includes a curtain body configured which encircles the upper body portion of the vehicle. This curtain body includes a peripheral upper portion configured to extend around the perimeter of the vehicle roof. The cover assembly further includes a curtain support apparatus for supporting the curtain body in a deployed condition covering the windows. The curtain support apparatus includes a reinforcing structure for reinforcing the curtain body and retaining the upper portion of the curtain body above the windows. A plurality of retention members have one end coupled to the curtain body and an opposite end mountable to the vehicle.

U.S. Patent Publication 2014/0265421 pertains to a vehicle cover that protects a vehicle from rain, snow, sun, dirt, dust, and bird droppings. The disposable vehicle cover can have a variety of shapes, such as oval shaped, rectangular shaped, cylindrical shaped, cubical shaped, or the like, in order to fit vehicles of different shapes. Once the vehicle cover gets soiled from the elements, a user may dispose of the vehicle cover. The disposable vehicle cover may be available in small, medium, and large sizes in order to accommodate different sized vehicles such as compact cars and full size SUVs. The vehicle (automobile) can include vehicles that do not travel on land, such as aircraft, hovercraft, and watercraft, as well as land vehicles.

U.S. Pat. No. 8,376,488 pertains to a tailgate cover that includes at least one pocket to securely fit over a tailgate. In some embodiments, this tailgate cover includes two or three pockets. The tailgate cover is made of stretchable material such as a stretchable fabric which enables the cover to be stretched securely over the tailgate. To further secure the tailgate cover over the tailgate, any coupling device is able to be used. The tailgate cover is able to include any graphic and/or text.

Various devices are known in the art. However, their structure and means of operation are substantially different from the present invention. Such devices fail to provide a device that provides for persistent notifications to a would-be rescuer. At least one embodiment of this invention is presented in the drawings below and will be described in more detail herein.

### SUMMARY OF THE EMBODIMENTS

The present invention provides for a device, comprising: a first panel, having a front surface and a bottom surface; an attachment mechanism, wherein said attachment mechanism is comprised of: at least one strap; and a fastening mechanism, integrated with said at least one strap, wherein said fastening mechanism is selected from the group consisting of: a plurality of hook and loop fasteners, at least one hook, at least one snap on button, at least one suction cup, or a plurality of magnets; a second panel; and an affixing mechanism, wherein said affixing mechanism provides for the removable detachment of said second panel from said front surface of said first panel and/or said second surface of said first panel, wherein said first panel and/or said second panel are equipped with text.

The present disclosure also provides for a device, comprising: a first panel, having a front surface and a bottom surface; an attachment mechanism, wherein said attachment mechanism is comprised of: at least one strap; and a fastening mechanism, integrated with said at least one strap, wherein said fastening mechanism is selected from the group consisting of: a plurality of hook and loop fasteners, at least one hook, at least one snap on button, at least one suction cup, or a plurality of magnets; a second panel; and an affixing mechanism, wherein said affixing mechanism provides for the removable detachment of said second panel from said front surface of said first panel and/or said second surface of said first panel. Further, the first and/or second panels of the device are optionally equipped with text that may be customized as well as at least one reflective element partially or entirely covering said device.

In general, the present invention succeeds in conferring the following, and other not mentioned, benefits and objectives.

It is an object of the present invention provide a means for alerting the public that help is needed.

It is an object of the present invention to promote safety.

It is an object of the present invention to prevent preventable deaths.

It is an object of the present invention to minimize the consequences of accidents.

### BRIEF DESCRIPTION OF THE DRAWINGS

FIG. 1 is a perspective view of an embodiment of the present invention.

FIG. 2 is a front view of an alternative embodiment of the present invention.

FIG. 3 is a perspective view of an embodiment of the invention, highlighting the invention's portable nature.

FIGS. 4A-4E are perspective views of the various ways in which an embodiment of the present invention may be attached to a vehicle.

FIGS. 5A-5C are perspective views of an embodiment of the present invention in use on different vehicles.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

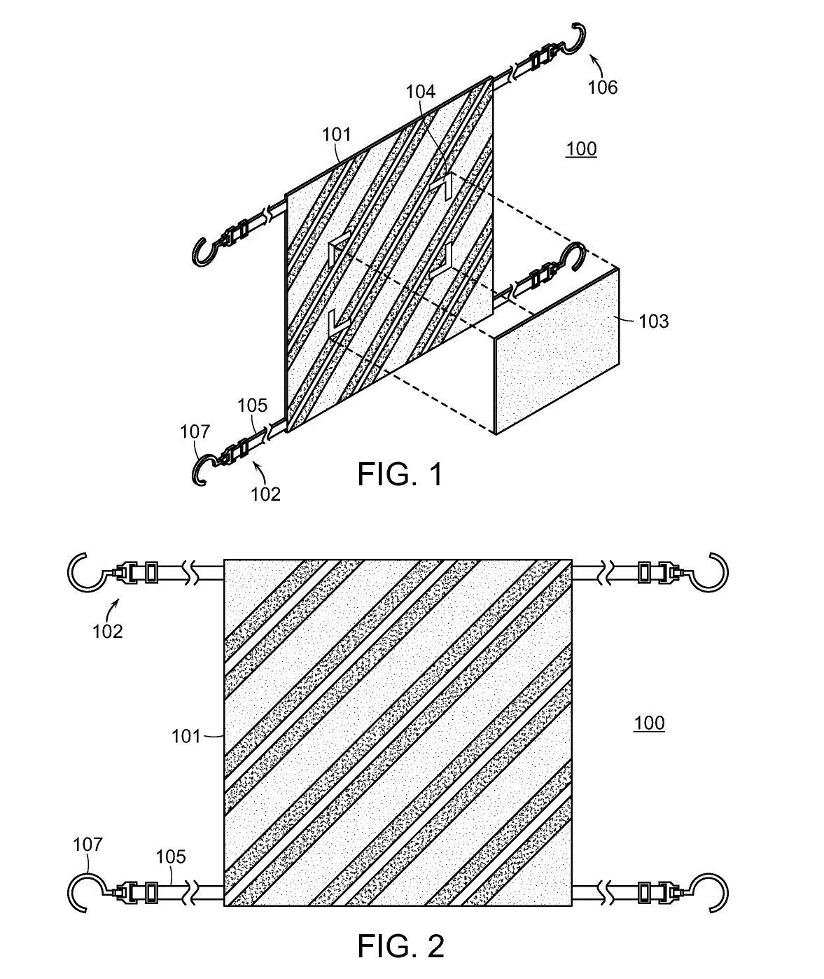

Referring to FIG. 1, a perspective view of an embodiment of the present invention is provided for. Specifically, safety device 100 is shown. In this particular embodiment, safety device 100 is comprised of first panel 101, attachment mechanism 102, second panel 103, affixing mechanism 104, at least one strap 105, fastening mechanism 106, and at least one hook 107. Here, attachment mechanism 102 is attached to first panel 101. Attachment mechanism 102 is used to attach safety device 100 to something that a user desires. In this embodiment, attachment mechanism 102 is comprised of at least one strap 105 and fastening mechanism 106, wherein fastening mechanism 106 consists of at least one hook. However, it should be noted that while here at least one hook 107 comprise fastening mechanism 106, many other devices, such as, for example, magnets, suction cups, and Velcro may be used in lieu of at least one hook. Affixing mechanism 104 provides for the removable detachment of second panel 103 from first panel 101. Such an embodiment may be optionally equipped with reflective elements (not pictured). In another a preferred embodiment, first panel 101 measures approximately 5′ by 5′. In yet another preferred embodiment, first panel 101 measures approximately 3′ by 3′.

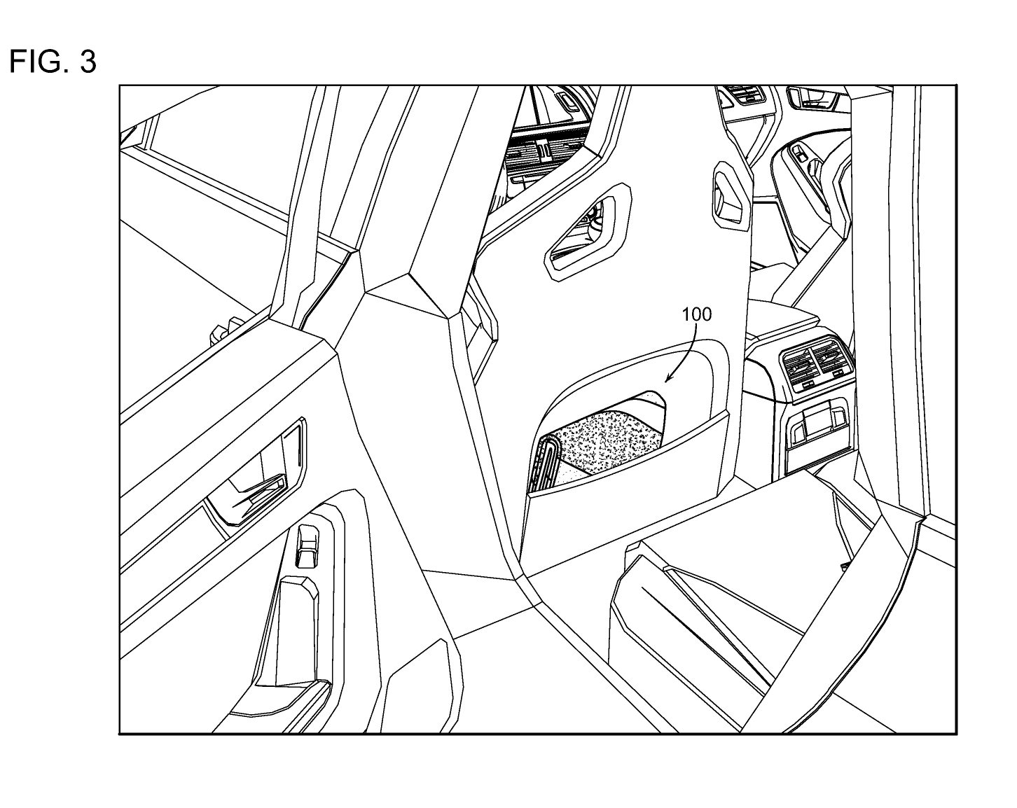

Referring to FIG. 2, a front view of an alternative embodiment of the safety device 100 is provided for. This embodiment features attachment mechanism 102, first panel 101, at least one strap 105, and at least one hook 107. In this embodiment too, attachment mechanism 102 is comprised of at least one strap 105 and at least one hook 107. Of note here is the fact that this embodiment is not equipped with second panel 103 (not pictured). Accordingly, many different combinations of first panel 101 and second panel 103 (not pictured) are contemplated by this disclosure.

FIG. 3 shows a perspective view of an embodiment of the invention, highlighting the invention's portable nature. Specifically, safety device 100 is shown tucked away in the rear-pocket of a driver's side seat in a standard automobile. The vehicle pictured is intended to be representative of a generic automobile, and is not intended to limit the application in any way. Rather, the convenience and portability of safety device 100 should be highlighted by FIG. 3.

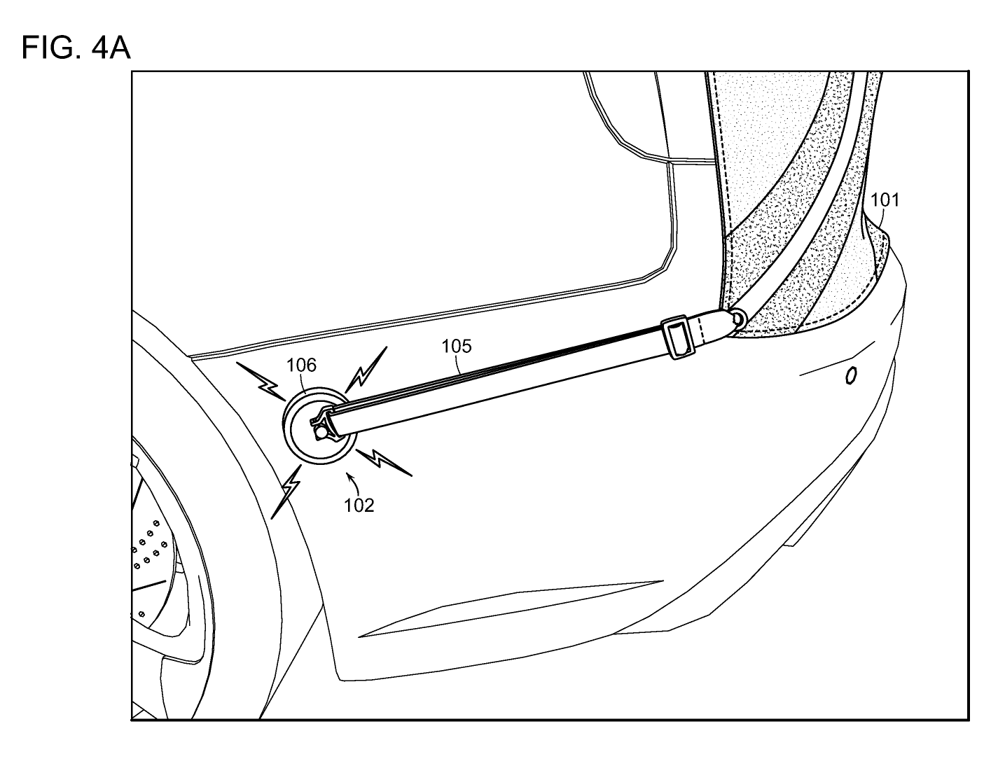

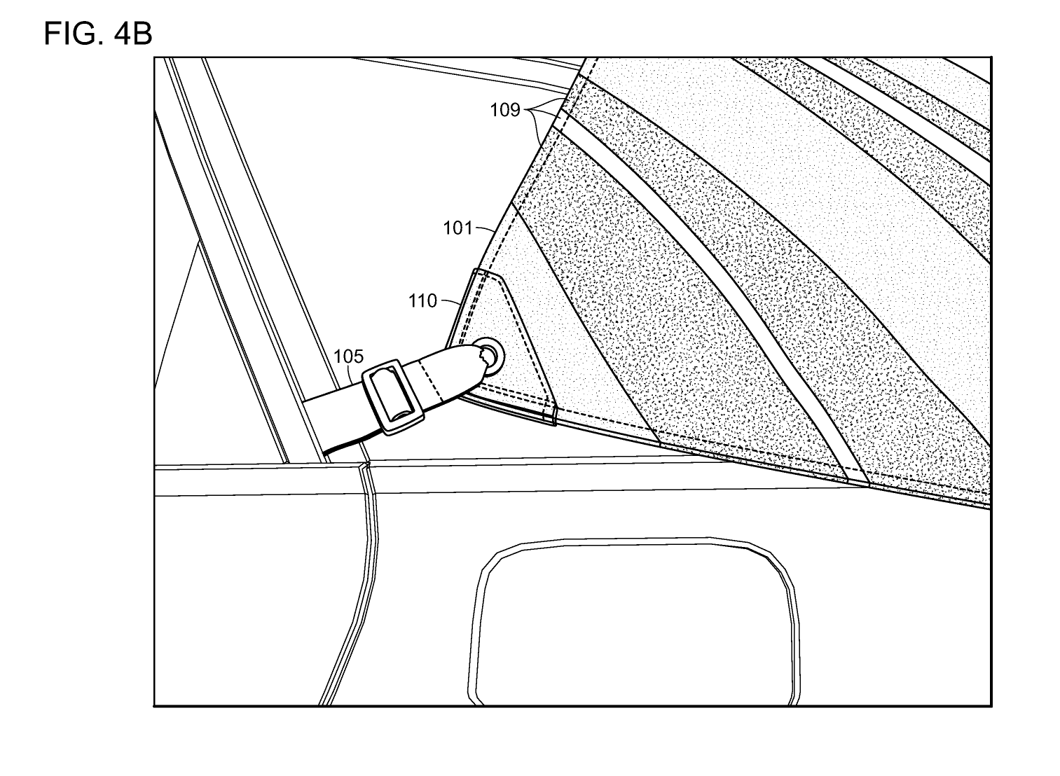

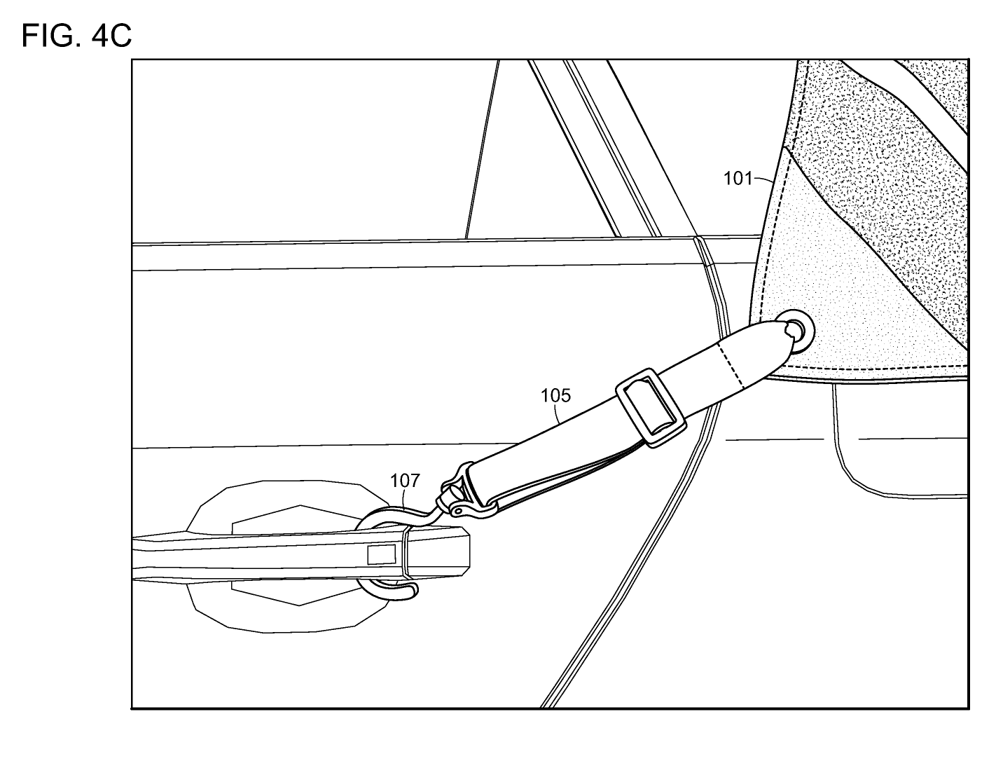

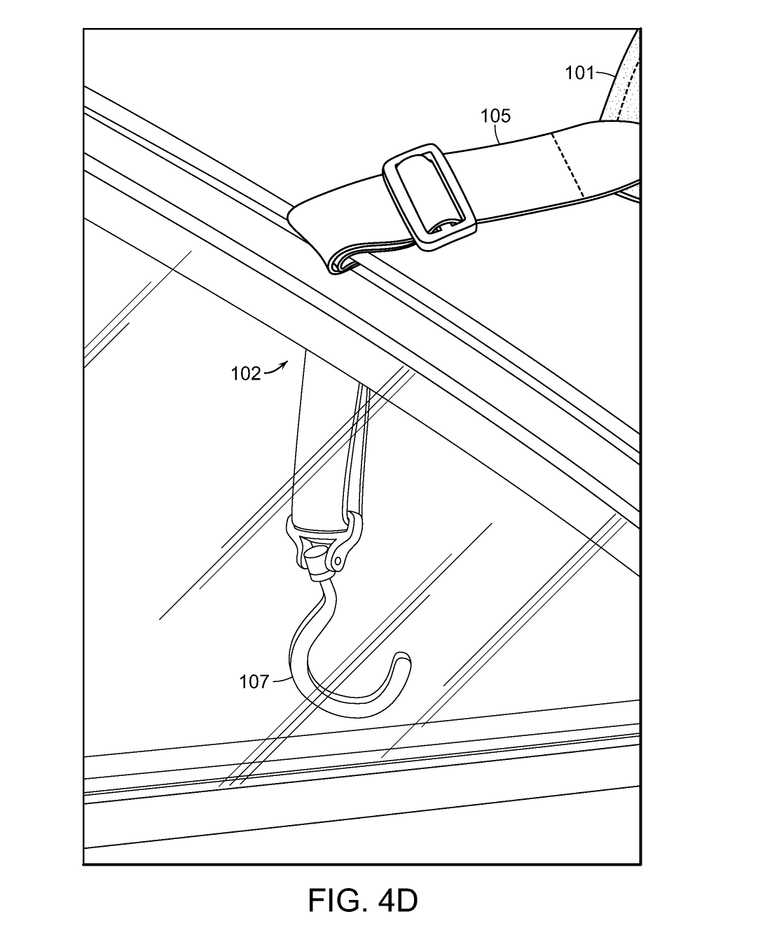

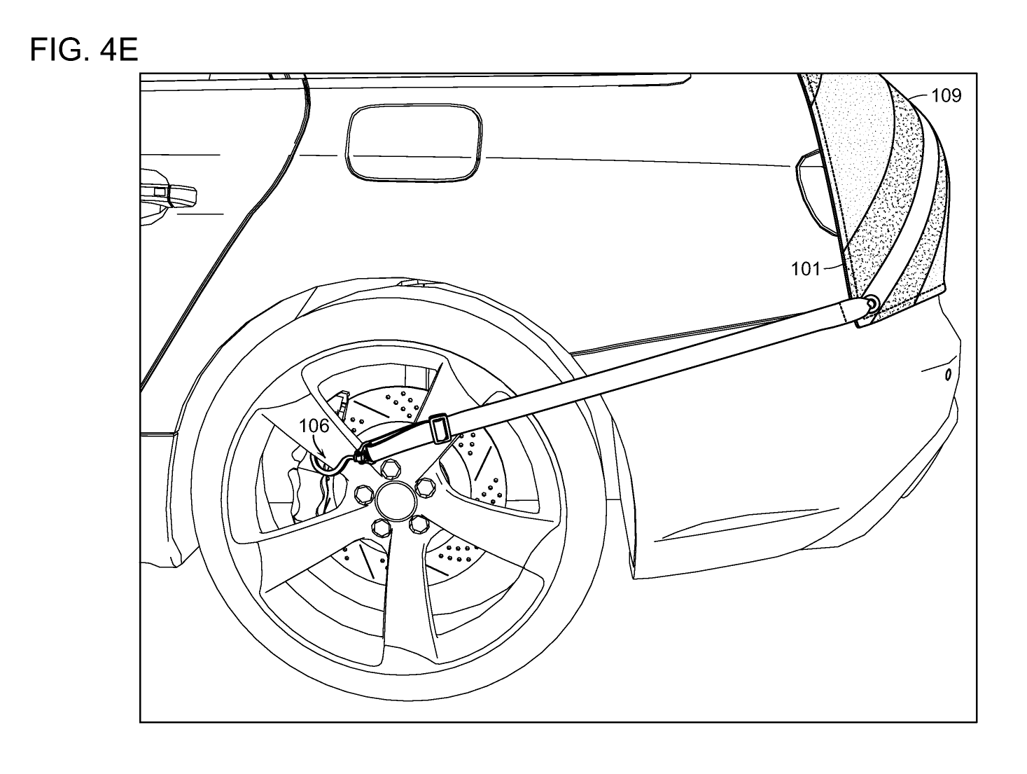

FIGS. 4A-4E are perspective views of the various ways in which an embodiment of the present invention may be attached to a vehicle.

Referring to FIG. 4A, an alternative embodiment of the present invention is shown. Here, the present invention is shown with first panel 101, at least one strap 105, fastening mechanism 106, and attachment mechanism 102. Similar to some of the previously mentioned embodiments, attachment mechanism 102 is comprised of at least one strap 105 and fastening mechanism 106. In this particular embodiment, fastening mechanism 106 is comprised of a magnet. Here, fastening mechanism 106 fastens the present invention to a vehicle by magnetically engaging a metal portion of the vehicle.

Referring to FIG. 4B, another method of attachment of the present invention is illustrated. Here, the present invention is comprised of first panel 101, reflective elements 109, reinforcements 110, and at least one strap 105. First panel 101 or second panel 103 (See FIG. 1) has been wholly or partially covered with reflective elements 109. The number of reflective elements can vary greatly based on a user's preference. Further, the present invention may be equipped with at least one light source, such as, for example, a light emitting diode. Reinforcements 110 are attached to first panel 101 near the area where at least one strap 105 interfaces with first panel 101. While this embodiment shows reinforcements 110 to be in a triangular shape, many other shapes and sizes are contemplated by this disclosure. Reinforcements 110 are equipped to prevent unnecessary wear-and-tear of a given embodiment of the present invention.

FIG. 4C shows an embodiment of the present invention, wherein at least one strap 105 and at least one hook 107 are used to attach the present invention to a vehicle by hooking at least one hook 107 on a handle of said vehicle.

FIG. 4D shows an alternative method of attachment of the present invention. Here attachment mechanism 102 is attached to first panel 101, and is again comprised of at least one strap 105 and at least one hook 107. Here, at least one hook 107 is not engaged with the vehicle. Rather, at least one strap 105 has been pressed between the seals of a vehicle's door. This view is intended to show another example of the multitude of ways the present invention may be attached to a vehicle.

FIG. 4E shows yet another alternative method of attachment of the present invention. Here, first panel 101 is equipped with reflective elements 109 along the stripes shown in this figure. Fastening mechanism 106 is also highlighted. In this embodiment, fastening mechanism 106 is comprised of a hook, however, many alternative fastening mechanisms are suitable. Such alternatives include, for example, magnets, a variety of adhesives, and/or rubber pads.

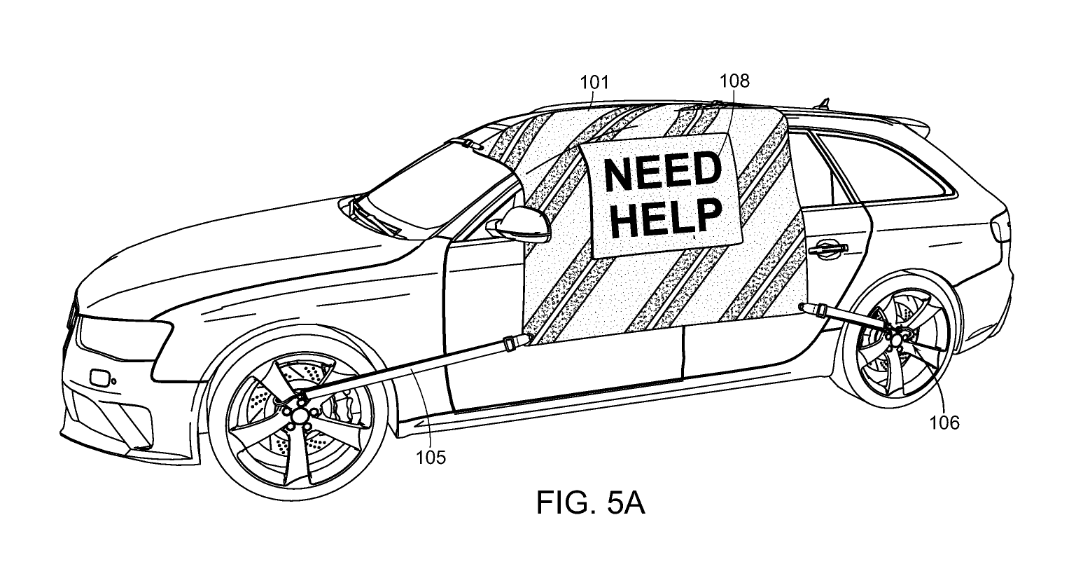

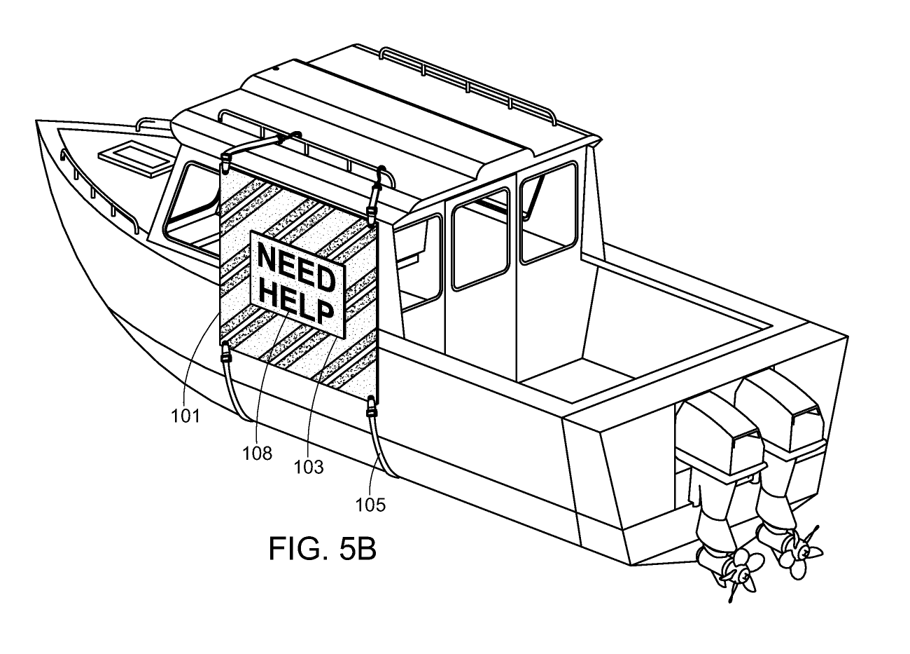

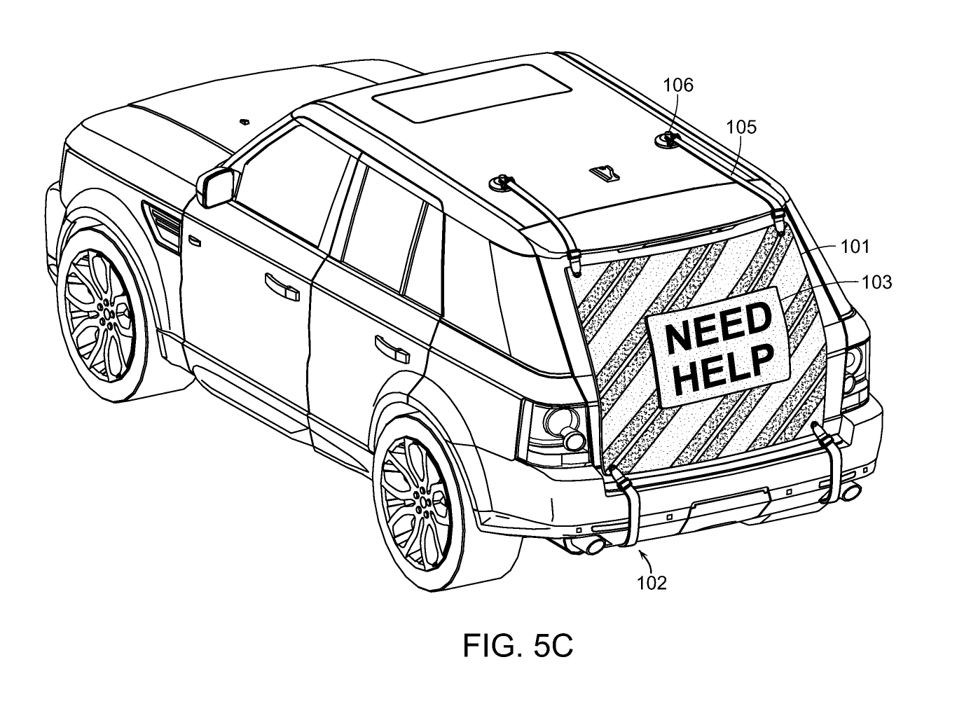

FIGS. 5A-5C are perspective views of an embodiment of the present invention in use on a number of different vehicles.

Referring to FIG. 5A, an embodiment of the present invention is provided. Here, the present invention is comprised of first panel 101, at least one strap 105, fastening mechanism 106, and text 108. While in this figure, text 108 consists of the characters “NEED HELP,” this display is merely intended to be representative and can take the form of any combination of characters as desired by the user. This view shows how the present invention may be used to passively signal for help, giving a user the option of resting inside the vehicle while waiting for help. In a preferred embodiment, text 108 may be reflective.

FIG. 5B shows an embodiment of the present invention while in use on a boat. This embodiment features, first panel 101, second panel 103, text 108, and at least one strap 105. This is intended to show the versatility of the vehicles upon which the present invention may be used.

FIG. 5C shows another embodiment of the present invention, while attached to the rear of an automobile. This embodiment is comprised of second panel 103 affixed to first panel 101 which is equipped with attachment mechanism 102, which in turn is comprised of at least one strap 105, fastening mechanism 106. Here, the present invention is sized such that it may be attached to the back of a vehicle without obstructing the rear lights of the vehicle. This is particularly useful for when the lights of a vehicle are still operational, providing for a greater visibility of the present invention.

In a preferred embodiment, first panel 101 is equipped with a set of lines are arranged in a contrasting pattern of light and dark colors. This increases the visibility, and consequently, the effectiveness of the present invention. However, this is not intended to limit the present invention as other patterns may be printed on either or both of first panel 101 and second panel 103.

In another preferred embodiment, safety device 100 is comprised of a lightweight, yet durable fabric. In some embodiments, this fabric is light permeable. This has the benefit of allowing a vehicle's lights to shine through the present invention, regardless of where on the vehicle it is attached. However, in other embodiments, the present invention is constructed out of fabric that is completely opaque.

In yet another preferred embodiment, the present invention may be equipped with at least one light source. This at least one light source may be placed at random locations throughout the present invention, or may be placed in a specific pattern, such as that resembling text, or a given image. This would have the additional benefit of displaying some message (e.g. “HELP,” “Call 911”) that could be seen regardless of the amount of ambient light.

When introducing elements of the present disclosure or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

While the disclosure refers to exemplary embodiments, it will be understood by those skilled in the art that various changes may be made and equivalents may be substituted for elements thereof without departing from the scope of the disclosure. In addition, many modifications will be appreciated by those skilled in the art to adapt a particular instrument, situation or material to the teachings of the disclosure without departing from the spirit thereof. Therefore, it is intended that the disclosure not be limited to the particular embodiments disclosed.

What is claimed is:

1. A safety device, comprising:
a first panel, having a front surface and a bottom surface; and
an attachment mechanism, connected to said first panel.

2. The safety device of claim 1, further comprising a second panel and an affixing mechanism,
wherein said affixing mechanism provides for the removable detachment of said second panel from said front surface of said first panel and/or said bottom surface of said first panel.

3. The safety device of claim 1, where said attachment mechanism is comprised of:
at least one strap; and
a fastening mechanism, integrated with said at least one strap.

4. The safety device of claim 3, where said fastening mechanism is selected from the group consisting of: a plurality of hook and loop fasteners, at least one hook, at least one snap on button, at least one suction cup, or a plurality of magnets.

5. The safety device of claim 2, where said affixing mechanism is selected from the group consisting of: a plurality of hook and loop fasteners, at least one hook, at least one snap on button, at least one suction cup, or a plurality of magnets.

6. The safety device of claim 5, wherein said at least one hook is constructed out of plastic.

7. The safety device of claim 1, wherein said first panel measures approximately 5′×5′.

8. The safety device of claim 1, wherein said first panel measures approximately 3′×5′.

9. The safety device of claim 2, wherein said first panel and/or said second panel contains text.

10. The safety device of claim 2, wherein said first panel and/or said second panel is equipped with reflective elements.

11. The safety device of claim 9, wherein said first panel and/or said second panel is equipped with reflective elements.

12. A device, comprising:
a first panel, having a front surface and a bottom surface;
an attachment mechanism,
wherein said attachment mechanism is comprised of:
at least one strap; and
a fastening mechanism, integrated with said at least one strap,
wherein said fastening mechanism is selected from the group consisting of: a plurality of hook and loop fasteners, a plurality of hooks, at least one snap on button, at least one suction cup, or a plurality of magnets;
a second panel; and
an affixing mechanism,
wherein said affixing mechanism provides for the removable detachment of said second panel from said front surface of said first panel and/or said bottom surface of said first panel.

13. The device of claim 12, wherein said first panel and/or said second panel are equipped with text.

14. The device of claim 12, wherein said first panel and/or said second panel are equipped with reflective elements.

15. The device of claim 13, wherein said first panel and/or said second panel are equipped with reflective elements.

16. The device of claim 1, wherein said first panel is equipped with reinforcements wherein said attachment mechanism is connected to said first panel.

17. The device of claim 1, further comprising at least one light source.

18. The device of claim 12, further comprising at least one light source.
